(19) United States
(12) Patent Application Publication
(10) Pub. No.: US 2024/0231062 A1
(43) Pub. Date: Jul. 11, 2024

(54) Long Focal Length, Five Mirror, Anastigmat Optical System

(71) Applicant: Raytheon Company, Waltham, MA (US)

(72) Inventor: Kyle Heideman, Hawthorne, CA (US)

(21) Appl. No.: 18/475,191

(22) Filed: Sep. 26, 2023

Related U.S. Application Data
(60) Provisional application No. 63/438,226, filed on Jan. 10, 2023.

(51) Int. Cl. G02B 17/00; G02B 5/10; G02B 9/60; G02B 17/06

(52) U.S. Cl. CPC G02B 17/008; G02B 5/10; G02B 9/60; G02B 17/0647

(57) ABSTRACT

The technology describes an image or optical system with a five-mirror anastigmat (5MA) with first, second and third mirrors cooperating to form an intermediate image between the third and a fourth mirror to enable longer focal lengths, higher pupil magnifications, the use of smaller mirrors and/or more compact designs that occupy less space.

### PRIORITY CLAIM

Priority is claimed to U.S. Provisional Patent Application No. 63/438,226, filed Jan. 10, 2023, which is hereby incorporated herein by reference.

### GOVERNMENT LICENSE RIGHTS

None.

### BACKGROUND

A variety of optical systems for various applications, such as telescopes, utilize long focal lengths and wide fields of view. Generally, long focal length optical systems can have long optical path lengths. In addition, a relatively wide field of view with a large aperture and a long focal length can result in a large optical system.

Reflective optical systems can be desirable for many wideband optical applications because they reflect all wavelengths of incident light equally, unlike refractive systems wherein the refraction is wavelength dependent. Reflective optical systems may also be made quite compact. However, reflective optical systems are typically more limited in their major-axis fields of view than are refractive systems, due to the poor image quality, image distortions, and potential obscuring of the ray paths when the wide field of view is attempted. Only one large dimension of field of view is normally required in many optical systems, in the “major axis”. A simultaneously large minor-axis field of view is either not necessary because the optical system is scanned along a direction, as in satellite-based earth-sensing applications, or because the minor-axis field of view is supplied by angularly scanning the optical system along the minor axis using a mechanical scanning device.

Five-mirror anastigmat (5MA) designs have been proposed that can achieve wide fields of view and support a relatively fast aperture. Such designs tend to be large when extended to long focal lengths.

The pursuit of image or optical systems with long focal lengths, high pupil magnification, smaller mirrors and/or smaller, more compact designs is an ongoing endeavor.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is a schematic view of a relayed, focal, unobscured reflective optical system with a ray tracing simulation according to one example embodiment.

FIG. 2 is a schematic view of another relayed, focal, unobscured reflective optical system with a ray tracing simulation according to another example embodiment.

FIG. 3 is a schematic view of another relayed, focal, unobscured reflective optical system with a ray tracing simulation according to another example embodiment.

Reference will now be made to the exemplary embodiments illustrated, and specific language will be used herein to describe the same. It will nevertheless be understood that no limitation of the scope of the invention is thereby intended.

### DETAILED DESCRIPTION

Before invention embodiments are disclosed and described, it is to be understood that no limitation to the particular structures, process steps, or materials disclosed herein is intended, but also includes equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating steps and operations and do not necessarily indicate a particular order or sequence. Unless defined otherwise, all technical and scientific terms used herein have the same meaning as commonly understood by one of ordinary skill in the art to which this disclosure belongs.

As used in this specification and the appended claims, the singular forms “a,” “an” and “the” include plural referents unless the context clearly dictates otherwise. Thus, for example, reference to “a layer” includes a plurality of such layers.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. When using an open ended term in the specification, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein.

The term “coupled,” as used herein, is defined as directly or indirectly connected in an electrical or nonelectrical manner. Objects described herein as being “adjacent to” each other may be in physical contact with each other, in close proximity to each other, or in the same general region or area as each other, as appropriate for the context in which the phrase is used. Occurrences of the phrase “in one embodiment,” or “in one aspect,” herein do not necessarily all refer to the same embodiment or aspect.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, the term “about” is used to provide flexibility to a numerical range endpoint by providing that a given value may be “a little above” or “a little below” the endpoint. It is understood that express support is intended for exact numerical values in this specification, even when the term “about” is used in connection therewith.

An initial overview of the inventive concepts are provided below and then specific examples are described in further detail later. This initial summary is intended to aid readers in understanding the examples more quickly, but is not intended to identify key features or essential features of the examples, nor is it intended to limit the scope of the claimed subject matter.

As described herein, existing five-mirror focal anastigmat (5MA) designs can achieve wide fields of view and can support relatively fast apertures, but tend to be large when extended to long focal lengths. The present technology utilizes five mirrors in a 5MA design, but moves the intermediate image to between the third and fourth mirrors, as opposed to between the second and third mirrors. Positioning the intermediate image between the third and fourth mirrors can enable longer focal lengths, higher pupil magnifications, the use of smaller mirrors and/or more compact designs that occupy less space. The present 5MA design can provide a larger aperture and a longer focal length in a smaller package.

In addition, the mirror conics can utilize freeform surface shapes.

The present technology and the present 5MA design can be scaled and can be utilized in optical systems, including telescopes. The present technology can replace four-mirror (4M) systems while providing improved performance and reduces size, weight and power (SWAP). In addition, the present technology can replace five-mirror (5M) systems while providing reduced costs for reduced mirror size, increased resolution, longer focal lengths and smaller size.

The present technology can be a relayed, focal, unobscured reflective image or optical system with mirrors directing electromagnetic radiation, such as light, along a beam path. The optical system comprises five mirrors forming an intermediate image between third and fourth mirrors. A first mirror can be operable to receive the beam path from a real entrance pupil. A second mirror can be operable to receive the beam path from the first mirror. The third mirror can be operable to receive the beam path from the second mirror. A fourth mirror can be operable to receive the beam path from the third mirror. A fifth mirror can be operable to receive the beam path from the fourth mirror and to direct the beam path to a real exit pupil.

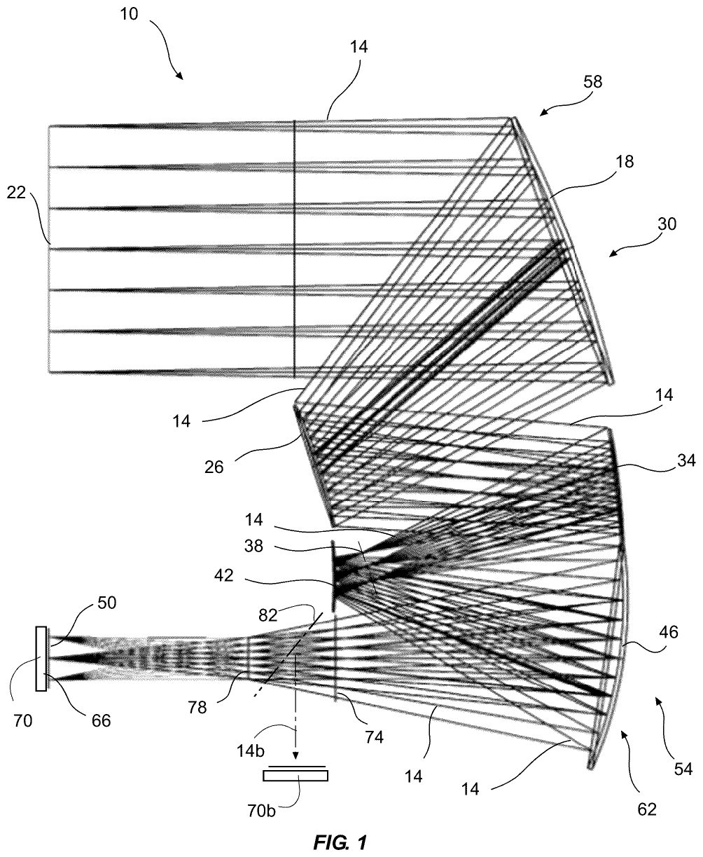

FIG. 1 shows a schematic of a relayed, focal, unobscured reflective imaging or optical system 10 with a ray tracing simulation according to one example embodiment. In one aspect, the optical system 10 can comprise or can be part of a telescope. The optical system 10 can be configured to direct electromagnetic radiation along a beam path 14. The optical system 10 can comprise five mirrors to form a five-mirror anastigmat (5MA). The 5MA of the optical system 10 can receive an image from an objective and relay the image to an eyepiece, to form a relayed optical system 10. The optical system 10 can be focal to produce a focused image at a specified image plane as an output, as opposed to afocal to produce collimated output (i.e. columnated light to columnated light). The system 10 and the 5MA focuses light from infinity to an image. In one aspect, each mirror of the 5MA can be a free-form mirror having conics with general polynomial surface deformations for better wavefront error (WFE) correction.

The optical system 10 can comprise a first mirror 18 to receive electromagnetic radiation from a real entrance pupil 22 and to reflect electromagnetic radiation along the beam path 14. The first mirror 18 can be powered with a positive optical power. A second mirror 26 can receive electromagnetic radiation from the first mirror 18 and reflect electromagnetic radiation along the beam path 14. The second mirror 26 can be powered with a negative optical power. In one aspect, the first and second mirrors 18 and 26 may form an afocal multi-mirror optical component 30 that operates as a substantial afocal pair (afocal or nearly afocal) with the beam path 14 reflected from the second mirror 26 being substantially columnar (columnar or nearly columnar).

A third mirror 34 can receive electromagnetic radiation from the second mirror 26 and reflect electromagnetic radiation along the beam path 14. The third mirror 34 can be powered with a positive optical power. An intermediate image 38 can be formed after the beam path 14 reflects from the third mirror 34. Thus, the first, second and third mirrors 18, 26 and 34 can cooperate for form the intermediate image 38. In one aspect, the first three mirrors 18, 26 and 34 may form a three-mirror imager that forms the intermediate image 38.

A fourth mirror 42 can receive electromagnetic radiation from the third mirror 34 and reflect electromagnetic radiation along the beam path 14. The fourth mirror 42 can be powered with a negative optical power. The intermediate image 38 on the beam path 14 can be reflected from the fourth mirror 42.

A fifth mirror 46 can receive electromagnetic radiation from the fourth mirror 42 and reflect electromagnetic radiation along the beam path 14 to a real exit pupil 50. The fifth mirror 46 can be powered with a positive optical power. Thus, the fifth mirror 46 can enable use as a compensator with a tilt the same as decenter on a sphere. In one aspect, the last two mirrors 42 and 46 may form a re-imager. The five powered mirrors 18, 26, 34, 42 and 46 can form the 5MA.

In one aspect, the third, fourth and fifth mirrors 34, 42 and 46 can comprise a three-mirror relayed imager 54 that receives light from the substantially afocal pair 30 and relays the light to the real exit pupil 50. In another aspect, the intermediate image 38 can be formed in the relayed imager 54. In another aspect, the optical system 10 may be considered to include a three-mirror objective 58 formed by the first, second and third mirrors 18, 26 and 34 which precede the intermediate image 38, followed by a two-mirror relayed imager 62 formed by the fourth and fifth mirrors 42 and 46.

The image location 66 can be after the real exit pupil 50. A detector 70, such as a focal plane array, can be positioned at the image location 66.

The optical system 10 can also have aperture stops 74 and 78 along the beam path 14 and positioned after the fifth mirror 46, and between the fifth mirror 46 and the exit pupil 50.

In one aspect, one of the aperture stops can be a Lyot stop 78. The Lyot stop 78 can facilitate stray light control and/or can provide for the use of a cold shield for infrared detectors.

The space between the aperture stops 74 and 78 can allow for placement of other optical elements 82, such as a beam splitter or an unpowered mirror. The optical element 82, such as the beam splitter or the unpowered mirror, can be positioned in the beam path 14 between the fifth mirror 46 and the exit pupil 50, and between the aperture stops 74 and 78. Creating space between the exit pupil and where the rays are crossing gives room for the beam splitter and provides a copy of the exit pupil to two separate image planes. The beam splitter can direct a portion of electromagnetic radiation along a separate path 14b separate from the beam path 14 and towards a detector 70b. The unpowered mirror can be a fold mirror to redirect the beam path 14b to the detector 70b. The unpowered mirror is not considered one of the five powered mirrors. The aperture stops 74 and 78 can also provide for independent cold stops for multiple bands. This can allow for independent F/# for different bands. This can be useful when longer wavelengths have the same modulation transfer function (MTF) requirement of shorter wavelength bands.

As described herein, the mirrors of the 5MA can be configured so that the intermediate image 38 is formed between the third mirror 34 and the fourth mirror 42. Thus, the optical system 10 can have a longer focal length, a relatively wide field of view (FOV), a large aperture, a higher pupil magnification, smaller mirrors and/or a more compact design that occupies less space.

In one aspect, utilizing aspheric or free-form conics (i.e. the first, second, third, fourth and fifth mirrors 18, 26, 34, 42 and 46 can be aspheric or free-form having conics with general polynomial surface deformations), a separation between proximate mirrors along the beam path 14 can be approximately a quarter of a focal length of the optical system 10 or the 5MA. The focal length is the distance from a rear principle plane to the image. The separation can be between sequential positive and negative powered mirrors. The separation can be substantially the same for sequential mirror with minor variations for alignment. Thus, the optical system 10 can have a length two times shorter than if the optical system had an intermediate image formed between a second and a third mirror. In another aspect, a partial field stop can be positioned in the beam path at the intermediate image.

In addition, the optical system 10 and the 5MA can have a height between a top of the first mirror 18 to a bottom of the fifth mirror 46. In one aspect, utilizing aspheric or free-form conics (i.e. the first, second, third, fourth and fifth mirrors 18, 26, 34, 42 and 46 can be aspheric or free-form having conics with general polynomial surface deformations), the height can be approximately ½ of the focal length of the optical system 10 or the 5MA.

As described herein, each mirror of the 5MA can have optical power. In one aspect, a sum of the optical powers of all the powered mirrors can be substantially zero to satisfy the Petzval sum criterion to form a flat image at the image location 66.

In another aspect, the field of view (FOV) in at least one axis (e.g. the major axis) can exceed about 1 degree in one aspect, and can exceed about 2 degrees in another aspect. In another aspect, the optical system 10 can have large field of view (FOV), such as 2×2 degree square. The FOV can be extend along a major axis to 4×2 degrees for a 2:1 aspect ratio. In one aspect, the mirrors of the 5MA can also have low field distortions of less than one percent. In another aspect, the mirrors of the 5MA can have distortion (f-tan theta or f*tan(Θ)) less than 0.01%.

In another aspect, the optical system 10 can have an optical speed and an F-number (F/#) slower than F/3. Locating the intermediate image 38 between the third mirror 34 and the fourth mirror 42 provides three mirrors 18, 26 and 34 before the intermediate image 38 allows the design to slow down the F/# of the intermediate image 38. Slowing down the F/# of the intermediate image 38 can reduce the size of the exit pupil 50 (i.e. pupil magnification). Reducing the size of the exit pupil 50 allows reduction the size of the back end of the telescope. In addition, the size of the cold stop and the cold cavity can be reduced for MWIR (Mid-Wave Infrared) and LWIR (Long-Wave Infrared) applications.

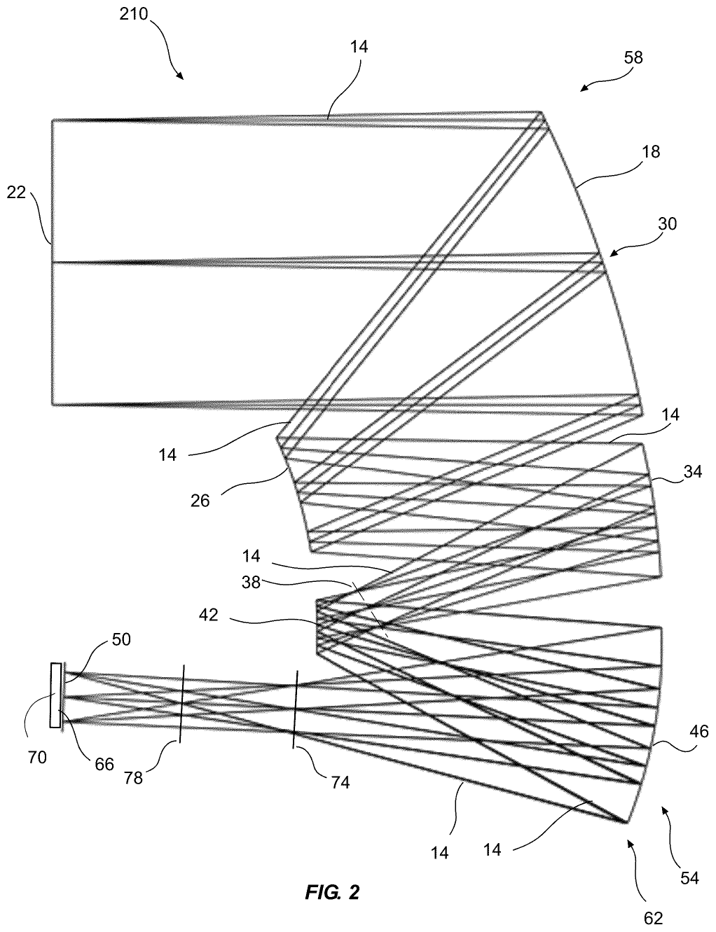

FIG. 2 shows a schematic of another relayed focal unobscured reflective imaging or optical system 210 with a ray tracing simulation according to another example embodiment. The imaging system 210 of FIG. 2 is similar in many respects to the imaging system 10 of FIG. 1, but can use only even aspheres that require fewer polynomials. As described herein, the mirrors can be conic (e.g. paraboloid, hyperboloid or ellipsoid) or a higher order aspheric.

An optical prescription for an example of the optical systems depicted herein is set forth in Table 1. The prescription is based on a design utilizing conics and even aspheres, scaled to unity focal length, 2×2 degree square field of view (FOV) at F/5. The prescription can be scaled by 1871× wavelength for diffraction limited performance focal length. For example, for diffraction limited performance at 1 um, the focal length would be 1871 mm with 374.2 mm entrance pupil diameter. Maximum root mean square (RMS) wavefront error (WFE) over the field of view (FOV) would be 0.07 waves at 1 um.

The convention for the prescription is based on U.S. Pat. No. 5,550,672 and US Patent Application Publication No. US 2003/0179444 (U.S. patent application Ser. No. 10/104,424); which are hereby incorporated herein by reference. The mirrors can be designed on a computer with ray-tracing software. Sag (z) represents a distance from an exact center of an arc to the center of its base. The Sag(z) of each of the mirrors can be determined by Equation 1:

$$z = \frac{C {τ}^{2}}{1 + \sqrt{1 - ( k + 1 ) {C}^{2} {τ}^{2}}} + D {τ}^{4} + E {τ}^{6} + F {τ}^{8} + G {τ}^{10} \qquad ( Equation 1 )$$

where:
C=1/radius of the mirror;
D, E, F and G are constants;
τ² is the radial distance on the mirror; and
K is a conic constant=−(eccentricity)².

From Equation 1, the prescription for the five-mirror anastigmat (5MA) can be generated. One prescription is shown in Table 1. The prescription of Table 1 is an example. The prescription of each 5MA may be determined by the intended application.

TABLE 1

| ID | Radius | K | D | E | F | G | T |
|---|---|---|---|---|---|---|---|
| First | 0.77113 | −0.57679 | −5.17E−02 | 7.49E−02 | 5.30E−02 | −5.98E−02 | −0.24271 |
| Mirror | | | | | | | |
| Second | 0.35810 | 0.79181 | −1.30E+00 | 3.47E+00 | 7.43E+01 | 1.57E+03 | 0.24271 |
| Mirror | | | | | | | |
| Third | 0.70552 | 6.61135 | −2.42E+00 | 7.86E+01 | −6.63E+02 | 1.09E+04 | −0.24271 |
| Mirror | | | | | | | |
| Fourth | 0.33997 | −33.11523 | −9.67E+01 | 2.38E+03 | 4.33E+05 | 4.14E+08 | 0.24271 |
| Mirror | | | | | | | |
| Fifth | 0.33334 | −0.80397 | −2.31E+00 | −9.69E+00 | −1.13E+02 | 1.16E+03 | −0.24271 |
| Mirror | | | | | | | |

In Table 1, T is the thickness (scaled to unity focal length). The entrance pupil 22 can have a thickness of 0.42847. The exit pupil 50 can have a thickness of −0.017663. The field/aperture offset can have a decenter (scaled to unity focal length) of −2.83E−01 and a tilt of 2.25E+00 degrees. The exit pupil 50 can have a decenter of −4.06E−02 and a tilt of 5.03E−01 degrees. The image can have a tilt of −4.55E−01 degrees.

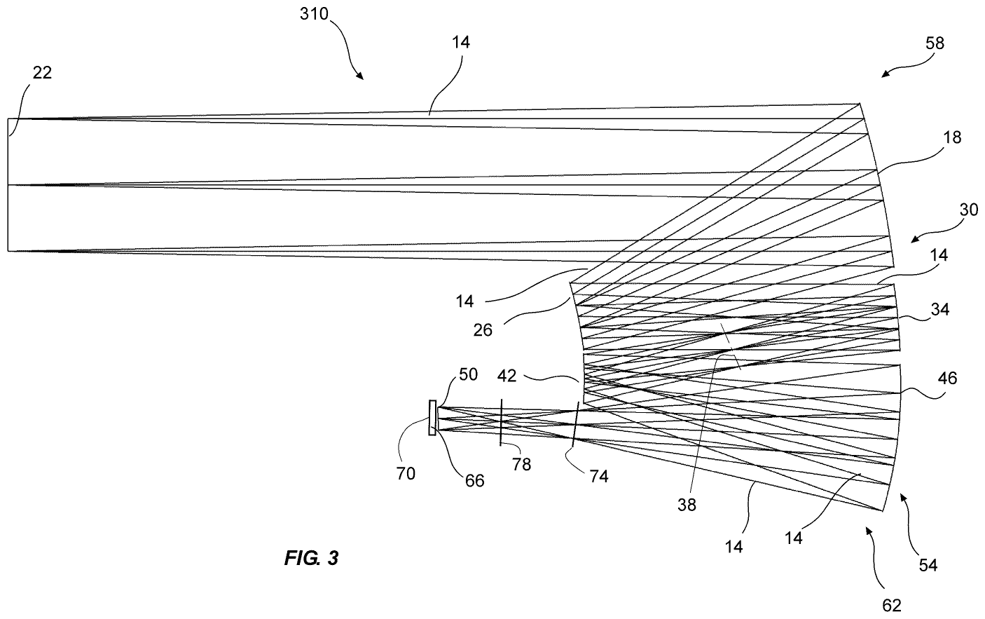

FIG. 3 shows a schematic of another relayed, focal, unobscured reflective imaging or optical system 310 with a ray tracing simulation according to another example embodiment. In one aspect, the first, second, third, fourth and fifth mirrors 18, 26, 34, 42 and 46 can be conic. The first mirror 18 can be substantially parabolic. In one aspect, the first mirror 18 can be mostly parabolic and slightly elliptical. The second mirror can be substantially hyperbolic. The third mirror can be substantially parabolic. The fourth mirror can be substantially oblate elliptical. The fifth mirror can be substantially spherical.

In one aspect, utilizing conic shapes, the optical system 310 can have a separation between proximate mirrors along the beam path 14 that is approximately half of a focal length of the optical system 310 or the 5MA. The focal length is the distance from a rear principle plane to the image. The separation can be between sequential positive and negative powered mirrors. The separation can be substantially the same for sequential mirror with minor variations for alignment. In addition, utilizing conic shapes, the optical system can have a height (between a top of the first mirror 16 and a bottom of the fifth mirror 46) can be approximately ⅔ the focal length of the optical system 310 or the 5MA.

An optical prescription for an example of the optical systems depicted herein is set forth in Table 2. The prescription is based on a design utilizing conics, scaled to unity focal length. The prescription of Table 2 is an example. The prescription of each 5MA may be determined by the intended application.

TABLE 2

| | R | K | T | decenter | Tilt (deg) |
|---|---|---|---|---|---|
| Entrance pupil | | | 1.34650 | | |
| Field/Aperture offset | | | | −3.74E−01 | 3.20E+00 |
| First Mirror | −1.39977 | −0.84702 | −0.47334 | 0.00E+00 | 0.00E+00 |
| Second Mirror | −0.60124 | −1.62483 | 0.47322 | 5.02E−04 | −1.29E+00 |
| Third Mirror | −1.04467 | −1.39588 | −0.47957 | 7.11E−03 | 3.87E−01 |
| Fourth Mirror | −0.64301 | 11.34825 | 0.47862 | 4.62E−02 | −2.44E+00 |
| Fifth Mirror | −0.65540 | 0.05885 | −0.47862 | 5.04E−02 | −1.73E+00 |
| Exit pupil | | | −0.21724 | −1.53E−02 | −5.94E−01 |
| Image | | | | | −4.33E+00 |

In Table 2, R is the radius, K is the conic constant defined herein, and T is the thickness (scaled to unity focal length.

The real entrance pupil 22 in the conic design of FIG. 3 is farther away from the mirrors. Such a design can be useful in some applications.

A method for imaging and for utilizing the optical systems 10, 210 and 310 described herein can comprise providing the relayed, focal, unobscured reflective optical system 10, 210 or 310 arranged along a beam path 14. The optical system 10, 210 or 310 can be directed to receive electromagnetic radiation through the real entrance pupil 22. In one aspect, directing the optical system can comprise positioning and orienting the optical system. An image can be detected, such as by a detector 70 positioned at the image location 66.

It is to be understood that the examples set forth herein are not limited to the particular structures, process steps, or materials disclosed, but are extended to equivalents thereof as would be recognized by those ordinarily skilled in the relevant arts. It should also be understood that terminology employed herein is used for the purpose of describing particular examples only and is not intended to be limiting.

Furthermore, the described features, structures, or characteristics may be combined in any suitable manner in one or more examples. In the description, numerous specific details are provided, such as examples of lengths, widths, shapes, etc., to provide a thorough understanding of the technology being described. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the foregoing examples are illustrative of the principles of the invention in one or more particular applications, it will be apparent to those of ordinary skill in the art that numerous modifications in form, usage and details of implementation can be made without the exercise of inventive faculty, and without departing from the principles and concepts described herein. Accordingly, it is not intended that the invention be limited, except as by the claims set forth below.

What is claimed is:

1. A relayed, focal, unobscured reflective optical system arranged along a beam path, the optical system comprising:
a first mirror operable to receive the beam path from a real entrance pupil;
a second mirror operable to receive the beam path from the first mirror;
a third mirror operable to receive the beam path from the second mirror;
a fourth mirror operable to receive the beam path from the third mirror;
a fifth mirror operable to receive the beam path from the fourth mirror and to direct the beam path to a real exit pupil; and
wherein an intermediate image is formed between the third mirror and the fourth mirror.

2. The optical system in accordance with claim 1, further comprising:
the intermediate image is formed after the beam path reflects from the third mirror; and
the intermediate image on the beam path is reflected from the fourth mirror.

3. The optical system in accordance with claim 1, further comprising:
the first and second mirrors comprising a substantial afocal pair;
the third, fourth and fifth mirrors comprising a three-mirror relayed imager that receives light from the substantial afocal pair and relays the light to the real exit pupil; and
the intermediate image is formed in the relayed imager.

4. The optical system in accordance with claim 1, wherein the first, second, third, fourth and fifth mirrors are conic; and further comprising:
a separation between proximate mirrors along the beam path is approximately half of a focal length of the optical system; and
a height between a top of the first mirror and a bottom of the fifth mirror that is approximately ⅔ of a focal length of the optical system.

5. The optical system in accordance with claim 1, wherein the first, second, third, fourth and fifth mirrors are aspheres; and further comprising:
a separation between proximate mirrors along the beam path is approximately a quarter of a focal length of the optical system.

6. The optical system in accordance with claim 1, wherein the first, second, third, fourth and fifth mirrors are aspheres or free-form having conics with general polynomial surface deformations; and further comprising:
a height between a top of the first mirror and a bottom of the fifth mirror that is approximately ½ of a focal length of the optical system.

7. The optical system in accordance with claim 1, further comprising:
the first mirror having a positive optical power;
the second mirror having a negative optical power;
the third mirror having a positive optical power;
the fourth mirror having a negative optical power; and
the fifth mirror having a positive optical power.

8. The optical system in accordance with claim 1, wherein the first, second, third, fourth and fifth mirrors are conic; and further comprising:
the first mirror is substantially parabolic;
the second mirror is substantially hyperbolic;
the third mirror is substantially parabolic;
the fourth mirror is substantially oblate elliptical; and
the fifth mirror is substantially spherical.

9. The optical system in accordance with claim 1, further comprising:
a beam splitter in the beam path between the fifth mirror and the exit pupil, the beam splitter configured to direct a portion of electromagnetic radiation along a separate path separate from the beam path.

10. The optical system in accordance with claim 1, further comprising:
an unpowered mirror in the beam path between the fifth mirror and the exit pupil, the unpowered mirror configured to direct a portion of electromagnetic radiation along a separate path separate from the beam path.

11. The optical system in accordance with claim 1, wherein:
each mirror is a free-form mirror having conics with general polynomial surface deformations.

12. The optical system in accordance with claim 1, wherein:
each mirror has an optical power; and
a sum of the optical powers of all the mirrors is substantially zero.

13. The optical system in accordance with claim 1, further comprising:
a field of view (FOV) of the optical system is at least 2×2 degrees.

14. The optical system in accordance with claim 1, wherein:
an optical speed of the optical system is slower than F/3.

15. The optical system in accordance with claim 1, further comprising:
a length of the optical system with the intermediate image formed between the third mirror and the fourth mirror is less than a length of an optical system with an intermediate image formed between a second and a third mirror.

16. A relayed, focal, unobscured reflective optical system configured to direct electromagnetic radiation along a beam path, the optical system comprising:
a first powered mirror configured to receive electromagnetic radiation from a real entrance pupil and to reflect electromagnetic radiation along the beam path, the first powered mirror having a positive optical power;
a second powered mirror configured to receive electromagnetic radiation from the first powered mirror and to reflect electromagnetic radiation along the beam path, the second powered mirror having a negative optical power;
a third powered mirror configured to receive electromagnetic radiation from the second powered mirror and to reflect electromagnetic radiation along the beam path, the powered third mirror having a positive optical power;
an intermediate image being formed after the beam path reflects from the third powered mirror;
a powered fourth mirror configured to receive electromagnetic radiation from the third powered mirror and to reflect electromagnetic radiation along the beam path, the fourth powered mirror having a negative optical power;
the intermediate image on the beam path being reflected from the fourth mirror; and
a powered fifth mirror configured to receive electromagnetic radiation from the fourth mirror and to reflect electromagnetic radiation along the beam path to a real exit pupil, the fifth mirror having a positive optical power.

17. The optical system in accordance with claim 16, wherein the first, second, third, fourth and fifth mirrors are aspheres; and further comprising:
a separation between proximate mirrors along the beam path is approximately a quarter of a focal length of the optical system.

18. The optical system in accordance with claim 16, wherein the first, second, third, fourth and fifth mirrors are aspheres or free-form having conics with general polynomial surface deformations; and further comprising:
a height between a top of the first mirror and a bottom of the fifth mirror that is approximately ½ of a focal length of the optical system.

19. The optical system in accordance with claim 16, wherein:
each mirror is a free-form mirror having conics with general polynomial surface deformations.

20. A method for imaging, comprising:
providing a relayed, focal, unobscured reflective optical system arranged along a beam path, the optical system comprising:
a first mirror operable to receive the beam path from a real entrance pupil;
a second mirror operable to receive the beam path from the first mirror;
a third mirror operable to receive the beam path from the second mirror;
a fourth mirror operable to receive the beam path from the third mirror;
a fifth mirror operable to receive the beam path from the fourth mirror and to direct the beam path to a real exit pupil; and
wherein an intermediate image is formed between the third mirror and the fourth mirror;
directing the optical system to receive electromagnetic radiation through the real entrance pupil; and
detecting an image.
